(19) United States
(12) Patent Application Publication
(10) Pub. No.: US 2025/0039742 A1
(43) Pub. Date: Jan. 30, 2025

(54) RELAY APPARATUS, COMMUNICATION SYSTEM, AND RELAY METHOD

(71) Applicant: NEC Corporation, Minato-ku, Tokyo (JP)

(72) Inventors: Anan SAWABE, Tokyo (JP); Yusuke SHINOHARA, Tokyo (JP); Takanori IWAI, Tokyo (JP)

(73) Assignee: NEC Corporation, Minato-ku, Tokyo (JP)

(21) Appl. No.: 18/717,051

(22) PCT Filed: Dec. 22, 2021
(86) PCT No.: PCT/JP2021/047644

§ 371 Date: Jun. 6, 2024

(51) Int. Cl. H04W 28/12; H04W 72/0446; H04W 72/12

(52) U.S. Cl. CPC H04W 28/12; H04W 72/0446; H04W 72/12

(57) ABSTRACT

A relay apparatus (100) according to the present disclosure includes: a communication unit (101) that transmits a downlink packet received from a transmission-side communication apparatus (200) via a network to a reception-side communication apparatus (300) via the network, and transmits an ACK packet for the downlink packet received from the reception-side communication apparatus (300) via the network to the transmission-side communication apparatus (200) via the network; and a transmission timing control unit (102) that controls transmission timing of the ACK packet by the communication unit (101) so as to transmit the received ACK packet at a specific interval.

### TECHNICAL FIELD

The present disclosure relates to a relay apparatus, a communication system, and a relay method.

### BACKGROUND ART

In a transmission control protocol (TCP), network congestion control is performed by a scheme called congestion window control (for example, Patent Literature 1).

In the congestion window control scheme, a transmission-side communication apparatus changes the size of the congestion window in correspondence with a congestion state of the network, and limits the amount of data (TCP segment) flowing in the network in accordance with the size of the congestion window.

Specifically, the transmission-side communication apparatus determines the congestion state of the network in accordance with the magnitude of a round trip time (RTT) that is time from when data flows to the network to time when an acknowledge (ACK) packet for the data is returned from the other party. When determining that the network is not congested in correspondence with the RTT, the transmission-side communication apparatus increases the size of the congestion window. On the other hand, when determining that the network is congested in correspondence with the RTT, the transmission-side communication apparatus decreases the size of the congestion window.

As a result, the transmission-side communication apparatus can flow a large amount of data to the network while avoiding network congestion.

### CITATION LIST

### Patent Literature

Patent Literature 1: Japanese Unexamined Patent Application Publication No. 2018-033119

### SUMMARY OF INVENTION

### Technical Problem

However, the present inventors have found a problem that in the congestion window control scheme, for example, in a case where the reception-side communication apparatus uses a time division duplex (TDD) scheme, when growth of the congestion window is stopped (the size does not increase), a dead time for which data is not transmitted although data can be transmitted occurs in the transmission-side communication apparatus.

Therefore, in consideration of the above-described problems, an object of the present disclosure is to provide a relay apparatus, a communication system, and a relay method capable of reducing a dead time in a transmission-side communication apparatus.

### Solution to Problem

A relay apparatus according to an aspect includes:
a communication unit configured to transmit a downlink packet received from a transmission-side communication apparatus via a network to a reception-side communication apparatus via the network, and transmit an acknowledge (ACK) packet for the downlink packet received from the reception-side communication apparatus via the network to the transmission-side communication apparatus via the network; and
a transmission timing control unit configured to control transmission timing of the ACK packet by the communication unit so as to transmit the received ACK packet at a specific interval.

A communication system according to another aspect includes:
a first communication unit configured to transmit a downlink packet received from a transmission-side communication apparatus via a network to a reception-side communication apparatus via the network, and transmit an acknowledge (ACK) packet for the downlink packet received from the reception-side communication apparatus via the network to the transmission-side communication apparatus via the network; and
a transmission timing control unit configured to control transmission timing of the ACK packet by the first communication unit so as to transmit the received ACK packet at a specific interval.

A relay method according to still another aspect is
a relay method by a relay apparatus, the method including:
a communication step of transmitting a downlink packet received from a transmission-side communication apparatus via a network to a reception-side communication apparatus via the network, and transmitting an acknowledge (ACK) packet for the downlink packet received from the reception-side communication apparatus via the network to the transmission-side communication apparatus via the network; and
a transmission timing control step of controlling transmission timing of the ACK packet in the communication step so as to transmit the received ACK packet at a specific interval.

### Advantageous Effects of Invention

According to the above-described aspects, it is possible to provide a relay apparatus, a communication system, and a relay method capable of reducing dead time in a transmission-side communication apparatus.

### BRIEF DESCRIPTION OF DRAWINGS

FIG. 1 is a view for explaining a problem in a congestion window control scheme.

FIG. 2 is a view illustrating an example of an RTT.

FIG. 3 is a view illustrating a configuration example of a communication system according to a first example embodiment.

FIG. 4 is a flowchart illustrating an example of a schematic operation flow of a relay apparatus according to the first example embodiment.

FIG. 5 is a view illustrating a configuration example of a communication system according to a second example embodiment.

FIG. 6 is a view illustrating an example of a schematic operation of a transmission timing control unit according to the second example embodiment.

FIG. 7 is a flowchart illustrating an example of a schematic operation flow of a proxy server according to the second example embodiment.

FIG. 8 is a view illustrating a configuration example of a communication system according to a third example embodiment.

FIG. 9 is a flowchart illustrating an example of a schematic operation flow of a Web server according to a third example embodiment.

FIG. 10 is a block diagram illustrating a hardware configuration example of a computer that implements the relay apparatus according to the first example embodiment, the proxy server according to the second example embodiment, and the Web server according to the third example embodiment.

### EXAMPLE EMBODIMENT

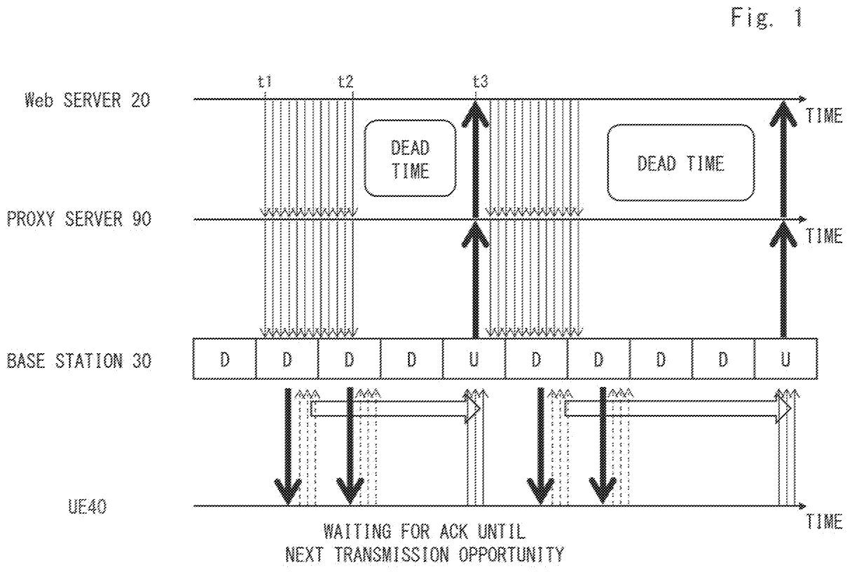

Before describing the present example embodiment, problems in a congestion window control scheme discovered by the present inventors will be described with reference to FIG. 1.

In the example of FIG. 1, a Web server 20 transmits data to a user equipment (UE) 40 via a proxy server 90 and a base station 30. That is, the Web server 20 serves as a transmission-side communication apparatus, the base station 30 serves as a reception-side communication apparatus, and the proxy server 90 serves as a relay apparatus. In addition, a TDD scheme is used for communication between the base station 30 and the UE 40. In addition, “D” in the drawing indicates a downlink slot which is a time slot allocated to a downlink from the base station 30 to the UE 40, and “U” in the drawing indicates an uplink slot which is a time slot allocated to an uplink from the UE 40 to the base station 30.

At time t1, the Web server 20 transmits a downlink packet of a data amount corresponding to a size of a congestion window at that time to the proxy server 90, and the proxy server 90 transmits the downlink packet to the base station 30. Since the downlink slot is allocated when the downlink packet is received from the proxy server 90, the base station 30 transmits the downlink packet received from the proxy server 90 to the UE 40.

When receiving the downlink packet, the UE 40 transmits an ACK packet for the downlink packet. However, the downlink slot is allocated when the downlink packet is received from the base station 30. Therefore, the UE 40 is kept waiting for transmission of the ACK packet until the transmission opportunity at time t3 at which the uplink slot is allocated. Then, at time t3, the UE 40 collectively transmits a plurality of ACK packets to the base station 30, and the base station 30 collectively transmits the plurality of ACK packets to the proxy server 90.

Here, although network congestion control is performed in TCP as described above, the network congestion control is also performed in QUIC. The QUIC is a protocol positioned on an upper side of a user datagram protocol (UDP).

In general, the proxy server 90 can terminate TCP by using a method such as TCP splitting and can intervene in congestion control on a relay apparatus such as the proxy server 90. On the other hand, in the QUIC, the relay apparatus such as the proxy server 90 cannot directly participate in the congestion control of the QUIC due to an influence that encryption by transport layer security (TLS) is performed on the UDP and the congestion control is performed in the upper layer. Therefore, with regard to the QUIC, the proxy server 90 transfers the ACK packet received from the base station 30 to the Web server 20 as it is.

When receiving the ACK packet from the base station 30, the Web server 20 resumes the transmission of the downlink packet. As described above, in the Web server 20, in order to transmit the next downlink packet, it is necessary to wait until the ACK packet is received. As a result, in the Web server 20, time from time t2 when transmission of the downlink packet is completed to time t3 when the ACK packet is received is a dead time during which the downlink packet is not transmitted although the downlink packet can be transmitted.

Furthermore, the Web server 20 determines whether or not the network is congested in correspondence with the RTT from transmission of the downlink packet to reception of the ACK packet.

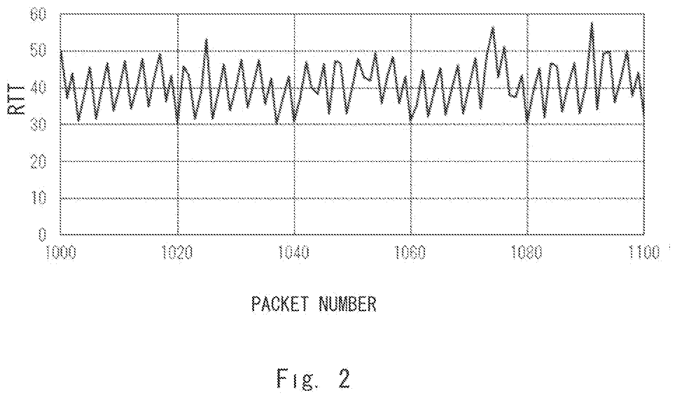

At this time, for example, it is assumed that the RTT is as illustrated in FIG. 2. In FIG. 2, the vertical axis represents an RTT, and the horizontal axis represents a packet number of the downlink packet. Here, the Web server 20 increments a packet number whenever transmitting a downlink packet. Therefore, the downlink packet with the largest packet number is the most recently transmitted downlink packet. In the example of FIG. 2, the RTT has a sawtooth shape. This is because the UE 40 collectively transmits a plurality of ACK packets, for a plurality of downlink packets received in a plurality of downlink slots, in one uplink slot, and the base station 30 and the proxy server 90 also collectively transmit the plurality of ACK packets.

In a case where the RTT has the sawtooth shape as illustrated in FIG. 2, the Web server 20 determines that the network is congested. Therefore, in the Web server 20, the growth of the congestion window stops (the size does not increase). Therefore, at the time of transmitting the next downlink packet, the Web server 20 can transmit only a downlink packet of a data amount corresponding to the size of the congestion window in the stopped growth state. As a result, in the Web server 20, a dead time occurs even after the next downlink packet is transmitted.

Example embodiments of the present disclosure will be described below with reference to the drawings. Note that, in the description and drawings to be described below, omission and simplification are made as appropriate for clarity of description. Furthermore, in each of the drawings described below, the same element is denoted by the same reference numeral, and redundant description will be omitted as necessary. In addition, specific numerical values and the like shown below are only examples to facilitate understanding of the present disclosure, and are not limited thereto.

### First Example Embodiment

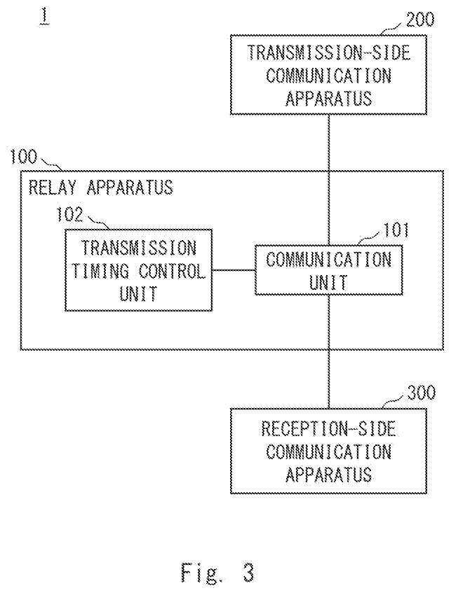

First, a configuration example of a communication system 1 according to a first example embodiment will be described with reference to FIG. 3.

As illustrated in FIG. 3, the communication system 1 according to the present first example embodiment includes a relay apparatus 100, a transmission-side communication apparatus 200 and a reception-side communication apparatus 300. Furthermore, the relay apparatus 100 includes a communication unit (first communication unit) 101 and a transmission timing control unit 102. Note that, the relay apparatus 100 is, for example, a proxy server, the transmission-side communication apparatus 200 is, for example, a Web server, and the reception-side communication apparatus 300 is, for example, a base station.

The communication unit 101 receives a downlink packet from the transmission-side communication apparatus 200 via the network, and transmits the downlink packet to the reception-side communication apparatus 300 via the network. Furthermore, the communication unit 101 receives an ACK packet for the downlink packet from the reception-side communication apparatus 300 via the network, and transmits the ACK packet to the transmission-side communication apparatus 200 via the network.

Note that, the network according to the present first example embodiment usually refers to a communication network including a communication network (whether wired or wireless) between the transmission-side communication apparatus 200 and the relay apparatus 100 and a communication network (whether wired or wireless) between the relay apparatus 100 and the reception-side communication apparatus 300. However, in a case where the reception-side communication apparatus 300 is a base station, the network refers to a communication network including the above-described communication network and a wireless communication network between the reception-side communication apparatus 300 and a terminal such as a UE.

The transmission timing control unit 102 controls transmission timing of the ACK packet by the communication unit 101 so as to transmit the ACK packet received from the reception-side communication apparatus 300 to the transmission-side communication apparatus 200 at a specific interval.

In response to this, the communication unit 101 transmits the ACK packet to the transmission-side communication apparatus 200 at the transmission timing controlled by the transmission timing control unit 102.

Note that, the transmission-side communication apparatus 200 may be realized by any communication apparatus as long as the communication apparatus has a function of transmitting a downlink packet to the relay apparatus 100 and receiving an ACK packet for the downlink packet from the relay apparatus 100. In addition, the reception-side communication apparatus 300 may be realized by any communication apparatus as long as the communication apparatus has a function of receiving a downlink packet from the relay apparatus 100 and transmitting an ACK packet for the downlink packet to the relay apparatus 100, or a function of receiving a downlink packet from the relay apparatus 100, transferring the downlink packet to another apparatus (when the reception-side communication apparatus 300 is a base station, another apparatus is a terminal such as a UE), receiving an ACK packet for the downlink packet from another apparatus, and transmitting the ACK packet to the relay apparatus 100. Therefore, detailed configurations of the transmission-side communication apparatus 200 and the reception-side communication apparatus 300 will not be described.

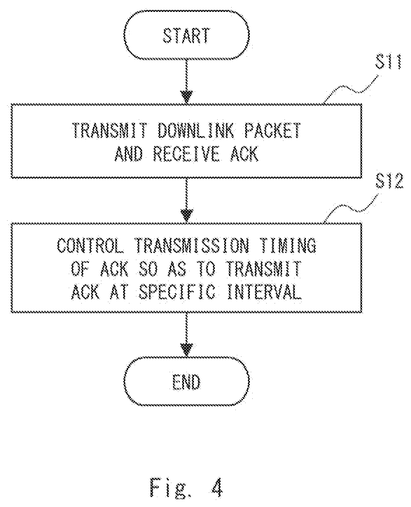

Next, an example of a schematic operation flow of the relay apparatus 100 according to the present first example embodiment will be described with reference to FIG. 4.

As illustrated in FIG. 4, the communication unit 101 transmits the downlink packet received from the transmission-side communication apparatus 200 via the network to the reception-side communication apparatus 300 via the network, and receives the ACK packet for the downlink packet from the reception-side communication apparatus 300 via the network (step S11).

Then, the transmission timing control unit 102 controls transmission timing of the ACK packet by the communication unit 101 so as to transmit the ACK packet received from the reception-side communication apparatus 300 to the transmission-side communication apparatus 200 at a specific interval (step S12).

According to the present first example embodiment described above, the relay apparatus 100 controls transmission timing of the ACK packet by the communication unit 101 so as to transmit the ACK packet received from the reception-side communication apparatus 300 to the transmission-side communication apparatus 200 at a specific interval. As a result, in the transmission-side communication apparatus 200, since the RTT does not have a sawtooth shape as illustrated in FIG. 2 and does not greatly fluctuate, it is determined that the network is not congested, and the congestion window can be grown (the size can be increased). As a result, in the transmission-side communication apparatus 200, the amount of data of the downlink packet flowing through the network increases, and thus, it is possible to reduce dead time.

Note that, the communication unit 101 may receive a plurality of ACK packets from the reception-side communication apparatus 300, and the transmission timing control unit 102 may control the transmission timing of the plurality of ACK packets by the communication unit 101 on the basis of a scheduling interval of the network and the number of the plurality of ACK packets received from the reception-side communication apparatus 300. For example, when the reception-side communication apparatus 300 is a base station that communicates with a terminal by a TDD scheme, the scheduling interval of the network may be an uplink slot interval allocated to the uplink. Note that, the scheduling interval of the network may be calculated by any constituent element in the relay apparatus 100 or may be received from an external device.

Furthermore, the communication unit 101 may receive a plurality of ACK packets from the reception-side communication apparatus 300 within a predetermined time corresponding to a predetermined slot, and the transmission timing control unit 102 may control the transmission timing of the plurality of ACK packets by the communication unit 101 on the basis of the scheduling interval of the network and the number of the plurality of ACK packets received within the predetermined time from the reception-side communication apparatus 300. For example, when the reception-side communication apparatus 300 is a base station that communicates with a terminal in the TDD scheme, the predetermined slot may be an uplink slot.

In addition, the transmission timing control unit 102 may control the transmission timing of the plurality of ACK packets by the communication unit 101 so that all of the plurality of ACK packets are transmitted within the scheduling interval of the network and the plurality of ACK packets are transmitted at regular intervals.

A second communication unit that transmits a downlink packet to the communication unit 101 in the relay apparatus 100 and receives an ACK packet for the downlink packet from the communication unit 101 in the relay apparatus 100, and a transmission rate control unit that acquires a state of the network and controls a transmission bit rate of the downlink packet by the second communication unit on the basis of the acquired state of the network may be further provided. In this case, the second communication unit may be provided in the transmission-side communication apparatus 200. In addition, the transmission rate control unit may acquire an increase/decrease status of the RTT in the network as the state of the network.

### Second Example Embodiment

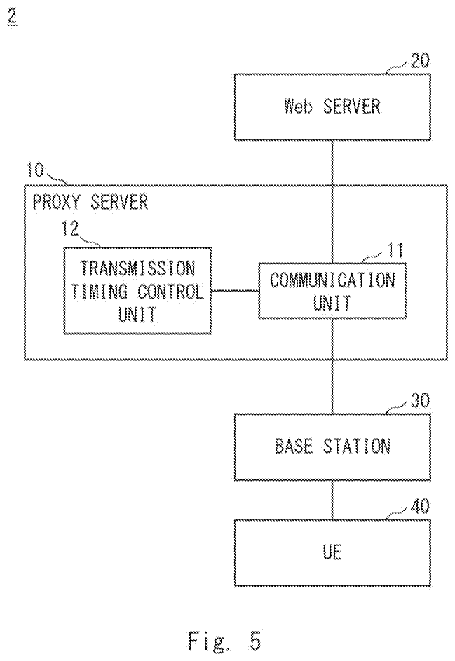

Next, a configuration example of a communication system 2 according to the present second example embodiment will be described with reference to FIG. 5. The second example embodiment corresponds to an example embodiment in which the above-described first example embodiment is further embodied.

As illustrated in FIG. 5, the communication system 2 according to the present second example embodiment includes a proxy server 10, a Web server 20, a base station 30, and a UE 40. Note that, a TDD scheme is used for communication between the base station 30 and the UE 40. In addition, the proxy server 10 is an example of a relay apparatus, the Web server 20 is an example of a transmission-side communication apparatus, and the base station 30 is an example of a reception-side communication apparatus.

The proxy server 10 includes a communication unit (first communication unit) 11 and a transmission timing control unit 12.

The communication unit 11 transmits a downlink packet received from the Web server 20 to the UE 40 via the base station 30, and transmits an ACK packet for the downlink packet received from the UE 40 via the base station 30 to the Web server 20.

Note that, the network according to the present second example embodiment refers to a communication network including a communication network (whether wired or wireless) between the Web server 20 and the proxy server 10, a communication network (whether wired or wireless) between the proxy server 10 and the base station 30, and a wireless communication network between the base station 30 and the UE 40. Note that, the wireless communication network between the base station 30 and the UE 40 may be long term evolution (LTE), 4G (generation), 5G, local 5G, or the like.

The transmission timing control unit 12 controls transmission timing of the ACK packet by the communication unit 11 so as to transmit the ACK packet received from the base station 30 to the Web server 20 at a specific interval.

In response to this, the communication unit 11 transmits the ACK packet at the transmission timing controlled by the transmission timing control unit 12 to the Web server 20.

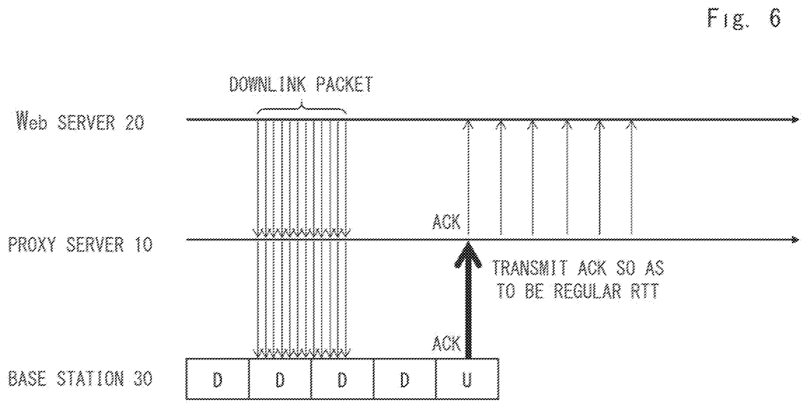

For example, as illustrated in FIG. 6, the transmission timing control unit 12 controls the transmission timing of the ACK packet so as to transmit the ACK packet at regular intervals. As a result, in the Web server 20, since the RTT does not greatly fluctuate, the congestion window can be grown (the size can be increased).

Next, the operation of the transmission timing control unit 12 will be described in detail.

As described above, a TDD scheme is used for communication between the base station 30 and the UE 40. Therefore, even when receiving the downlink packet in the downlink slot, the UE 40 cannot immediately transmit the ACK packet for the downlink packet and waits until an uplink slot which is the next transmission opportunity. Therefore, the UE 40 collectively transmits a plurality of ACK packets, for a plurality of downlink packets transmitted by the base station 30 in a plurality of downlink slots, in one uplink slot. In addition, the base station 30 also collectively transmits the plurality of ACK packets to the proxy server 10.

Therefore, the communication unit 11 collectively receives a plurality of ACK packets from the base station 30 within time corresponding to the uplink slot.

Therefore, the transmission timing control unit 12 controls the transmission timing of the ACK packet so that all of the plurality of ACK packets can be transmitted within a period until the next uplink slot and the plurality of ACK packets can be transmitted at regular intervals.

Specifically, the transmission timing control unit 12 sets a scheduling interval of the network, that is, an uplink slot interval as 8.

Then, the transmission timing control unit 12 sets the transmission timing aᵢ of the i^{th} ACK packet as in the following Mathematical Expression 1.

$${a}_{i} = {a}_{i - 1} + \frac{δ}{n} \qquad [ Mathematical Expression 1 ]$$

Here, n is the number of ACK packets collectively received from the base station 30 within time corresponding to the uplink slot.

Note that, the Web server 20 may be realized by any server as long as the server has a function of transmitting a downlink packet to the proxy server 10 and receiving an ACK packet for the downlink packet from the proxy server 10. In addition, the base station 30 may be realized by any base station as long as the base station has a function of communicating with the UE 40 by the TDD scheme, and a function of receiving a downlink packet from the Proxy server 10, transferring the downlink packet to the UE 40, receiving an ACK packet for the downlink packet from the UE 40, and transmitting the ACK packet to the proxy server 10. In addition, the UE 40 may be realized by any terminal as long as the terminal has a function of communicating with the base station 30 by the TDD scheme and a function of receiving a downlink packet from the base station 30 and transmitting an ACK packet for the downlink packet to the base station 30. Therefore, detailed configurations of the web server 20, the base station 30, and the UE 40 will not be described.

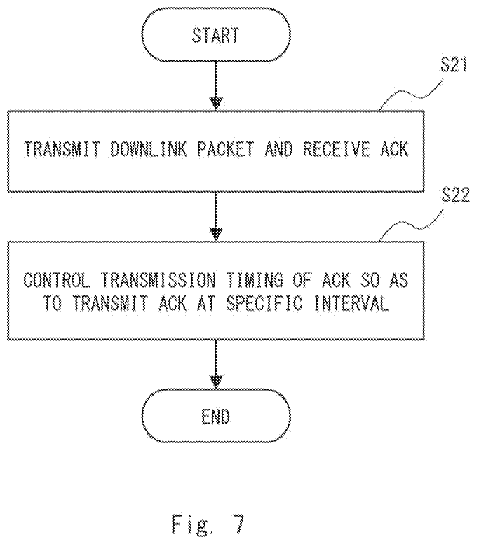

Next, an example of a schematic operation flow of the proxy server 10 according to the present second example embodiment will be described with reference to FIG. 7.

As illustrated in FIG. 7, the communication unit 11 transmits a downlink packet received from the web server 20 to the base station 30, and receives an ACK packet for the downlink packet from the base station 30 (step S21).

Then, the transmission timing control unit 12 controls transmission timing of the ACK packet by the communication unit 11 so as to transmit the ACK packet received from the base station 30 to the Web server 20 at a specific interval (step S22).

As described above, according to the present second example embodiment, the proxy server 10 controls the transmission timing of the ACK packet by the communication unit 11 so as to transmit the ACK packet received from the base station 30 to the web server 20 at a specific interval. As a result, in the Web server 20, since the RTT does not have a sawtooth shape as illustrated in FIG. 2 and does not greatly fluctuate, it is determined that the network is not congested, and the congestion window can be grown (the size can be increased). As a result, in the Web server 20, the amount of data of the downlink packet flowing through the network increases, and thus, it is possible to reduce dead time.

### Third Example Embodiment

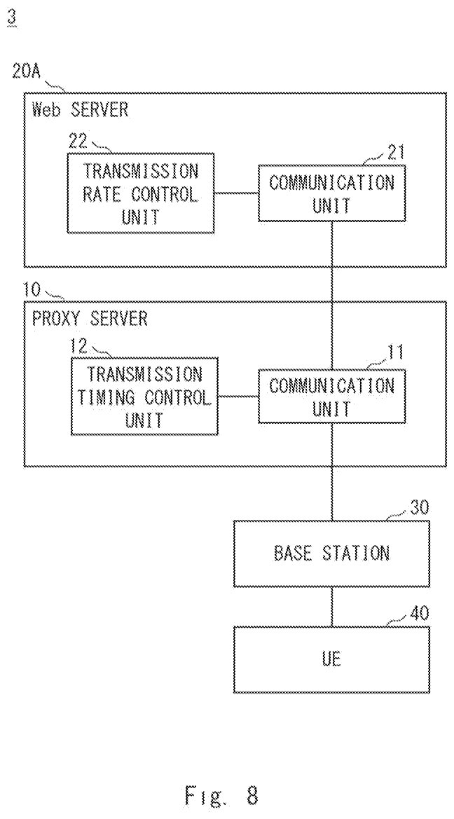

Next, a configuration example of a communication system 3 according to the present third example embodiment will be described with reference to FIG. 8. As illustrated in FIG. 8, the communication system 3 according to the present third example embodiment is different from the above-described second example embodiment in that the Web server 20 is replaced with a Web server 20A.

The web server 20A includes a communication unit (second communication unit) 21 and a transmission rate control unit 22.

The communication unit 21 transmits a downlink packet to the proxy server 10 and receives an ACK packet for the downlink packet from the proxy server 10.

The transmission rate control unit 22 acquires a state of the network and controls a transmission bit rate of the downlink packet by the communication unit 21 on the basis of the acquired state of the network. For example, the transmission rate control unit 22 acquires an increase/decrease status of the RTT in the network as the state of the network.

In response to this, the communication unit 21 transmits the downlink packet to the proxy server 10 at a transmission bit rate controlled by the transmission rate control unit 22.

Next, the operation of the transmission rate control unit 22 will be described in detail.

The transmission rate control unit 22 acquires an increase/decrease status of the RTT in the network as the state of the network. Here, it is assumed that the increase/decrease status of the RTT indicates any of increase, stable, and decrease.

For example, when the RTT is increasing, the transmission rate control unit 22 decreases the transmission bit rate Rate (t) [bps] of the ACK packet. For example, the transmission rate control unit 22 sets Rate (t) as in the following Mathematical Expression 2.

$$Rate ( t ) = α \times Rate ( t - 1 ) \qquad [ Mathematical Expression 2 ]$$

Here, α is a coefficient satisfying a relationship of 0<α<1.

On the other hand, when the RTT is stable or decreasing, the transmission rate control unit 22 increases the transmission bit rate Rate (t) [bps] of the ACK packet. For example, the transmission rate control unit 22 sets Rate (t) as in the following Mathematical Expression 3.

$$Rate ( t ) = Rate ( t - 1 ) + β \times Rate ( t - 1 ) \qquad [ Mathematical Expression 3 ]$$

Here, β is a coefficient satisfying a relationship of 0<β<1.

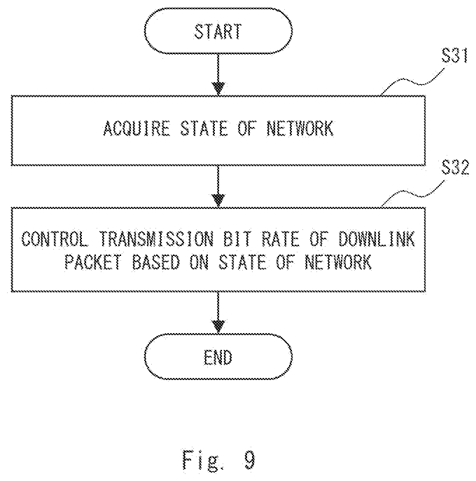

Next, an example of a schematic operation flow of the Web server 20A according to the present third example embodiment will be described with reference to FIG. 9.

As illustrated in FIG. 9, first, the transmission rate control unit 22 acquires a state of the network (step S31).

Then, the transmission rate control unit 22 controls the transmission bit rate of the downlink packet by the communication unit 21 on the basis of the acquired state of the network (step S32).

Note that, the configuration and operation of the present third example embodiment other than the web server 20A are similar to those of the second example embodiment described above. Therefore, description of configurations and operations other than those of the web server 20A is omitted.

As described above, according to the present third example embodiment, the web server 20A can increase the amount of data of the ACK packet flowing to the network by growing the congestion window, but when the amount of data exceeds an allowable amount that can be transmitted in the downlink slot existing between two uplink slots, a queuing delay occurs. Then, the Web server 20A acquires a state of the network and controls a transmission bit rate of the downlink packet by the communication unit 21 on the basis of the state of the network. As a result, in correspondence with the state of the network, it is possible to control the amount of data of the downlink packet flowing to the network so that the queuing delay does not occur. As a result, in the Web server 20, a throughput can be improved.

The effect of the present third example embodiment other than the above described effect is similar to that of the second example embodiment described above.

### <Hardware Configuration of Relay Apparatus, Proxy Server, and Web Server According to Example Embodiment>

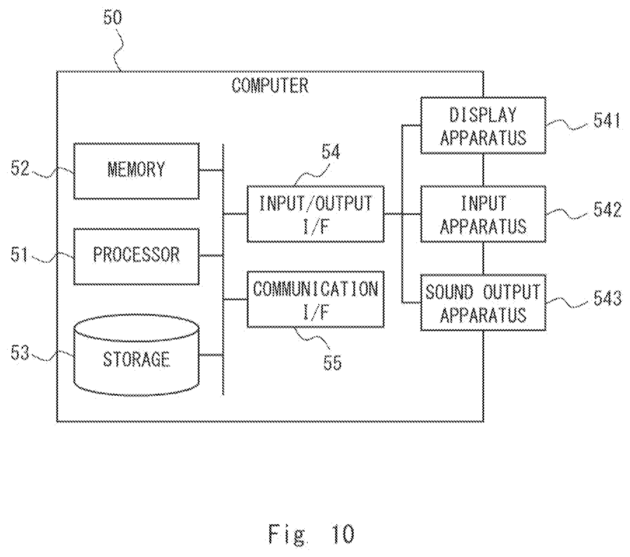

Next, a hardware configuration example of a computer 50 that realizes the relay apparatus 100 according to the first example embodiment described above, the proxy server 10 according to the second example embodiment described above, and the Web server 20A according to the third example embodiment described above will be described with reference to FIG. 10.

As illustrated in FIG. 10, the computer 50 includes a processor 51, a memory 52, a storage 53, an input/output interface (input/output I/F) 54, a communication interface (communication I/F) 55, and the like. The processor 51, the memory 52, the storage 53, the input/output interface 54, and the communication interface 55 are connected by a data transmission path for mutually transmitting and receiving data.

The processor 51 is, for example, an arithmetic processing apparatus such as a central processing unit (CPU) and a graphics processing unit (GPU). The memory 52 is, for example, a memory such as a random access memory (RAM) and a read only memory (ROM). The storage 53 is, for example, a storage device such as a hard disk drive (HDD), a solid state drive (SSD), and a memory card. Furthermore, the storage 53 may be a memory such as a RAM and a ROM.

The storage 53 stores programs for realizing the functions of the constituent elements included in the relay apparatus 100, the proxy server 10, or the Web server 20A. The processor 51 realizes the functions of the constituent elements included in the relay apparatus 100, the proxy server 10, or the Web server 20A by executing the programs. Here, in execution of each of the programs described above, the processor 51 may load the programs into the memory 52, and may execute the programs, or may execute the programs without loading the programs into the memory 52. In addition, the memory 52 and the storage 53 also serve to realize a storage function included in the relay apparatus 100, the proxy server 10, or the Web server 20A.

Furthermore, the above-described programs include a command group (or software code) for causing the computer to perform one or more functions in the relay apparatus 100, the proxy server 10, or the Web server 20A described in the above-described example embodiments when being read by the computer. The program may be stored in a non-transitory computer-readable medium or a tangible storage medium. As an example and not by way of limitation, the computer readable medium or the tangible storage medium includes a RAM, a ROM, a flash memory, an SSD or other memory technologies, a compact disc (CD)-ROM, a digital versatile disc (DVD), a Blu-ray (registered trademark) disk or other optical disk storages, a magnetic cassette, a magnetic tape, a magnetic disk storage, or other magnetic storage apparatuses. The program may be transmitted on a transitory computer readable medium or a communication medium. As an example and not by way of limitation, the transitory computer readable medium or the communication medium includes an electrical signal, an optical signal, an acoustic signal, or other forms of propagation signals.

The input/output interface 54 is connected to a display apparatus 541, an input apparatus 542, a sound output apparatus 543, and the like. The display apparatus 541 is an apparatus that displays a screen corresponding to drawing data processed by the processor 51 such as a liquid crystal display (LCD), a cathode ray tube (CRT) display, and a monitor. The input apparatus 542 is an apparatus that receives an operation input of an operator, and is, for example, a keyboard, a mouse, a touch sensor, or the like. The display apparatus 541 and the input apparatus 542 may be integrated and realized as a touch panel. The sound output apparatus 543 is an apparatus that acoustically outputs a sound corresponding to audio data processed by the processor 51 such as a speaker.

The communication interface 55 transmits and receives data to and from an external apparatus. For example, the communication interface 55 performs communication with the external apparatus via a wired communication line or a wireless communication line.

The present disclosure has been described above with reference to the example embodiments, but the present disclosure is not limited to the example embodiments described above. Various modifications that can be understood by those skilled in the art can be made to the configuration and details of the present disclosure within the scope of the present disclosure.

In addition, some or all of the above-described example embodiments may be described in supplementary notes below, but are not limited thereto.

### (Supplementary Note 1)

A relay apparatus including:
a communication unit configured to transmit a downlink packet received from a transmission-side communication apparatus via a network to a reception-side communication apparatus via the network, and transmit an acknowledge (ACK) packet for the downlink packet received from the reception-side communication apparatus via the network to the transmission-side communication apparatus via the network; and
a transmission timing control unit configured to control transmission timing of the ACK packet by the communication unit so as to transmit the received ACK packet at a specific interval.

### (Supplementary Note 2)

The relay apparatus according to Supplementary Note 1, wherein
the communication unit receives a plurality of the ACK packets from the reception-side communication apparatus, and
the transmission timing control unit controls transmission timing of the plurality of ACK packets by the communication unit on the basis of a scheduling interval of the network and the number of the plurality of ACK packets received from the reception-side communication apparatus.

### (Supplementary Note 3)

The relay apparatus according to Supplementary Note 1, wherein
the communication unit receives a plurality of the ACK packets from the reception-side communication apparatus within a predetermined time corresponding to a predetermined slot, and
the transmission timing control unit controls transmission timing of the plurality of ACK packets by the communication unit on the basis of a scheduling interval of the network and the number of the plurality of ACK packets received within the predetermined time from the reception-side communication apparatus.

### (Supplementary Note 4)

The relay apparatus according to Supplementary Note 2 or 3, wherein the transmission timing control unit controls transmission timing of the plurality of ACK packets by the communication unit so that all of the plurality of ACK packets are transmitted within the scheduling interval of the network and the plurality of ACK packets are transmitted at regular intervals.

### (Supplementary Note 5)

A communication system including:
a first communication unit configured to transmit a downlink packet received from a transmission-side communication apparatus via a network to a reception-side communication apparatus via the network, and transmit an acknowledge (ACK) packet for the downlink packet received from the reception-side communication apparatus via the network to the transmission-side communication apparatus via the network; and
a transmission timing control unit configured to control transmission timing of the ACK packet by the first communication unit so as to transmit the received ACK packet at a specific interval.

### (Supplementary Note 6)

The communication system according to Supplementary Note 5, wherein
the first communication unit receives a plurality of the ACK packets from the reception-side communication apparatus, and
the transmission timing control unit controls transmission timing of the plurality of ACK packets by the first communication unit on the basis of a scheduling interval of the network and the number of the plurality of ACK packets received from the reception-side communication apparatus.

### (Supplementary Note 7)

The communication system according to Supplementary Note 5, wherein
the first communication unit receives a plurality of the ACK packets from the reception-side communication apparatus within a predetermined time corresponding to a predetermined slot, and
the transmission timing control unit controls transmission timing of the plurality of ACK packets by the first communication unit on the basis of a scheduling interval of the network and the number of the plurality of ACK packets received within the predetermined time from the reception-side communication apparatus.

### (Supplementary Note 8)

The communication system according to Supplementary Note 6 or 7, wherein the transmission timing control unit controls transmission timing of the plurality of ACK packets by the first communication unit so that all of the plurality of ACK packets are transmitted within the scheduling interval of the network and the plurality of ACK packets are transmitted at regular intervals.

### (Supplementary Note 9)

The communication system according to any one of Supplementary Notes 5 to 8, further including:
a second communication unit provided in the transmission-side communication apparatus, the second communication unit being configured to transmit a downlink packet to the first communication unit via the network and receive an ACK packet for the downlink packet from the first communication unit via the network; and
a transmission rate control unit configured to acquire a state of the network and control a transmission bit rate of a downlink packet by the second communication unit on the basis of the acquired state of the network.

### (Supplementary Note 10)

The communication system according to Supplementary Note 9, wherein the transmission rate control unit acquires an increase/decrease status of a round trip time (RTT) which is time from when the transmission-side communication apparatus transmits a downlink packet to when the transmission-side communication apparatus receives an ACK packet for the downlink packet as the state of the network.

### (Supplementary Note 11)

A relay method by a relay apparatus, the method including:
a communication step of transmitting a downlink packet received from a transmission-side communication apparatus via a network to a reception-side communication apparatus via the network, and transmitting an acknowledge (ACK) packet for the downlink packet received from the reception-side communication apparatus via the network to the transmission-side communication apparatus via the network; and
a transmission timing control step of controlling transmission timing of the ACK packet in the communication step so as to transmit the received ACK packet at a specific interval.

### (Supplementary Note 12)

The relay method according to Supplementary Note 11, wherein
in the communication step, a plurality of the ACK packets are received from the reception-side communication apparatus, and
in the transmission timing control step, transmission timing of the plurality of ACK packets in the communication step is controlled on the basis of a scheduling interval of the network and the number of the plurality of ACK packets received from the reception-side communication apparatus.

### (Supplementary Note 13)

The relay method according to Supplementary Note 11, wherein
in the communication step, a plurality of the ACK packets are received from the reception-side communication apparatus within a predetermined time corresponding to a predetermined slot, and
in the transmission timing control step, transmission timing of the plurality of ACK packets in the communication step is controlled on the basis of a scheduling interval of the network and the number of the plurality of ACK packets received within the predetermined time from the reception-side communication apparatus.

### (Supplementary Note 14)

The relay method according to Supplementary Note 12 or 13, wherein, in the transmission timing control step, transmission timing of the plurality of ACK packets in the communication step is controlled so that all of the plurality of ACK packets are transmitted within a scheduling interval of the network and the plurality of ACK packets are transmitted at regular intervals.

### REFERENCE SIGNS LIST

1, 2, 3 COMMUNICATION SYSTEM
100 RELAY APPARATUS
101 COMMUNICATION UNIT
102 TRANSMISSION TIMING CONTROL UNIT
200 TRANSMISSION-SIDE COMMUNICATION APPARATUS
300 RECEPTION-SIDE COMMUNICATION APPARATUS
10 PROXY SERVER
11 COMMUNICATION UNIT
12 TRANSMISSION TIMING CONTROL UNIT
20, 20A WEB SERVER
21 COMMUNICATION UNIT
22 TRANSMISSION RATE CONTROL UNIT
30 BASE STATION
40 UE
50 COMPUTER
51 PROCESSOR
52 MEMORY
53 STORAGE
54 INPUT/OUTPUT INTERFACE
541 DISPLAY APPARATUS
542 INPUT APPARATUS
543 SOUND OUTPUT APPARATUS
55 COMMUNICATION INTERFACE

What is claimed is:

1. A relay apparatus comprising:
a transceiver configured to transmit a downlink packet received from a transmission-side communication apparatus via a network to a reception-side communication apparatus via the network, and transmit an acknowledge (ACK) packet for the downlink packet received from the reception-side communication apparatus via the network to the transmission-side communication apparatus via the network;
at least one memory storing instructions, and
at least one processor configured to execute the instructions to control transmission timing of the ACK packet by the transceiver so as to transmit the received ACK packet at a specific interval.

2. The relay apparatus according to claim 1, wherein
the transceiver receives a plurality of the ACK packets from the reception-side communication apparatus, and
the at least one processor is further configured to execute the instructions to control transmission timing of the plurality of ACK packets by the transceiver on the basis of a scheduling interval of the network and the number of the plurality of ACK packets received from the reception-side communication apparatus.

3. The relay apparatus according to claim 1, wherein
the transceiver receives a plurality of the ACK packets from the reception-side communication apparatus within a predetermined time corresponding to a predetermined slot, and
the at least one processor is further configured to execute the instructions to control transmission timing of the plurality of ACK packets by the transceiver on the basis of a scheduling interval of the network and the number of the plurality of ACK packets received within the predetermined time from the reception-side communication apparatus.

4. The relay apparatus according to claim 2, wherein the at least one processor is further configured to execute the instructions to control transmission timing of the plurality of ACK packets by the transceiver so that all of the plurality of ACK packets are transmitted within the scheduling interval of the network and the plurality of ACK packets are transmitted at regular intervals.

5. A communication system comprising:
a first transceiver configured to transmit a downlink packet received from a transmission-side communication apparatus via a network to a reception-side communication apparatus via the network, and transmit an acknowledge (ACK) packet for the downlink packet received from the reception-side communication apparatus via the network to the transmission-side communication apparatus via the network;
at least one memory storing instructions, and
at least one processor configured to execute the instructions to control transmission timing of the ACK packet by the first transceiver so as to transmit the received ACK packet at a specific interval.

6. The communication system according to claim 5, wherein
the first transceiver receives a plurality of the ACK packets from the reception-side communication apparatus, and
the at least one processor is further configured to execute the instructions to control transmission timing of the plurality of ACK packets by the first transceiver on the basis of a scheduling interval of the network and the number of the plurality of ACK packets received from the reception-side communication apparatus.

7. The communication system according to claim 5, wherein
the first transceiver receives a plurality of the ACK packets from the reception-side communication apparatus within a predetermined time corresponding to a predetermined slot, and
the at least one processor is further configured to execute the instructions to control transmission timing of the plurality of ACK packets by the first transceiver on the basis of a scheduling interval of the network and the number of the plurality of ACK packets received within the predetermined time from the reception-side communication apparatus.

8. The communication system according to claim 6, wherein the at least one processor is further configured to execute the instructions to control transmission timing of the plurality of ACK packets by the first transceiver so that all of the plurality of ACK packets are transmitted within the scheduling interval of the network and the plurality of ACK packets are transmitted at regular intervals.

9. The communication system according to claim 5, further comprising:
a second transceiver provided in the transmission-side communication apparatus, the second transceiver being configured to transmit a downlink packet to the first transceiver via the network and receive an ACK packet for the downlink packet from the first transceiver via the network;
wherein the at least one processor is further configured to execute the instructions to acquire a state of the network and control a transmission bit rate of a downlink packet by the second transceiver on the basis of the acquired state of the network.

10. The communication system according to claim 9, wherein the at least one processor is further configured to execute the instructions to acquire an increase/decrease status of a round trip time (RTT) which is time from when the transmission-side communication apparatus transmits a downlink packet to when the transmission-side communication apparatus receives an ACK packet for the downlink packet as the state of the network.

11. A relay method by a relay apparatus, the method comprising:
a communication step of transmitting a downlink packet received from a transmission-side communication apparatus via a network to a reception-side communication apparatus via the network, and transmitting an acknowledge (ACK) packet for the downlink packet received from the reception-side communication apparatus via the network to the transmission-side communication apparatus via the network; and
a transmission timing control step of controlling transmission timing of the ACK packet in the communication step so as to transmit the received ACK packet at a specific interval.

12. The relay method according to claim 11, wherein
in the communication step, a plurality of the ACK packets are received from the reception-side communication apparatus, and
in the transmission timing control step, transmission timing of the plurality of ACK packets in the communication step is controlled on the basis of a scheduling interval of the network and the number of the plurality of ACK packets received from the reception-side communication apparatus.

13. The relay method according to claim 11, wherein
in the communication step, a plurality of the ACK packets are received from the reception-side communication apparatus within a predetermined time corresponding to a predetermined slot, and
in the transmission timing control step, transmission timing of the plurality of ACK packets in the communication step is controlled on the basis of a scheduling interval of the network and the number of the plurality of ACK packets received within the predetermined time from the reception-side communication apparatus.

14. The relay method according to claim 12, wherein, in the transmission timing control step, transmission timing of the plurality of ACK packets in the communication step is controlled so that all of the plurality of ACK packets are transmitted within a scheduling interval of the network and the plurality of ACK packets are transmitted at regular intervals.
